(19) United States
(12) Patent Application Publication
(10) Pub. No.: US 2012/0135259 A1
(43) Pub. Date: May 31, 2012

(54) PRINTABLE BUILDING PANEL AND METHOD FOR PRODUCING A BUILDING PANEL

(75) Inventor: Jörg R. Bauer, Weingarten (DE)

(73) Assignee: INTERGLARION LIMITED, Engomi, Nikosia (CY)

(21) Appl. No.: 13/264,583

(22) PCT Filed: Apr. 16, 2010
(86) PCT No.: PCT/EP2010/055044

§ 371 Date: Feb. 21, 2012

(30) Foreign Application Priority Data
Apr. 16, 2009 (DE) 10 2009 017 661.6

(51) Int. Cl. B32B 29/00; B32B 29/06

(52) U.S. Cl. 428/537.5; 156/346

(57) ABSTRACT

With a building board with a base body (10) with a porous surface and a paper web (14) applied onto the porous surface with intermediate arrangement of a curable binder (36), the paper web applied onto the base body is provided with a primer (34) that is suitable for covering binder that has penetrated through the paper web (10) and for promoting an adhesion between the surface of the paper web and a dyeing liquid (38), which can be applied to the surface of the paper web provided with the adhesion promoter by means of a programmable printing method, in particular an inkjet printing method.

The invention relates to a printable building board with a base body with porous surface and a paper web applied to the porous surface. The invention further relates to a method for producing a printable building board of this type.

For the interior finishing of buildings, building boards of mineral fiber or plaster are generally used, which are applied to a support structure, for example, a metal frame or masonry. Subsequently, building boards of this type, if a wall, ceiling etc. formed thereby is to be painted, are sealed with a curing compound, which forms a paintable surface, or, if the wall is to be wallpapered, are provided with a corresponding paste.

A building board is known from U.S. Pat. No. 5,707,689 which is produced by pressing a cement material inserted into a mold. The surface of this building board is sealed with a primer and then printed with an ink-jet printing method.

From DE 20 2006 004 493 U1 a decoratively coated fire-retardant board is known, which is produced by providing a non-flammable fiber board, for example, a cement-bonded chipboard or gypsum fiber board with a primer in order to close the pores thereof and to harden the surface, and the surface is subsequently directly printed, optionally after smoothing.

It is known from DE 195 328 19 A1 to produce a wood material board, the initially porous surface of which is primed with aqueous emulsion paint, wherein a paint base is produced at the same time. The surface is then sealed and provided with a finish coat, subsequently printed and finally sealed with a UV-curable coat.

A plaster building board is known from DE 600 34 188 T2, which is produced by introducing wet plaster between two pasting paper layers, after the drying of which a building board coated on both sides is obtained. At least one of the pasting paper layers is pre-decorated before being used to produce the building board, in that successively several layers of water-soluble pigment coat are applied to the pasting paper. It is known from DE 102 52 863 A1 to print a paper web with a desired decoration, for example, a wood grain, and subsequently to coat the printed paper web with resin and to apply it to a wood fiber support board.

A building board consisting of a base body such as, for instance, asphalt board or press board on which a decorated latex paper is applied, is known from U.S. Pat. No. 2,035,760. When printing latex paper, only the paper web is pulled through a printing press. The decorated latex paper is subsequently applied on the asphalt board or press board under application of a binder.

A method for production of a plaster board is known from WO 99/57371 A, where a plaster mixture is cast between two paper layers and subsequently dried. During the drying process, water is excreted through the paper layers.

A plaster board is also known from U.S. Pat. No. 3,382,636 A, where a plaster middle part is incorporated between two paper layers.

One characteristic of building boards hitherto known with a porous base body and a paper layer applied to at least one side is that the paper layer is printed with a pattern before the application, whereby the pattern can be arranged in a precisely predetermined manner to the building board only with great expenditure.

The object of the invention is to remedy the above problem.

Claim 1 characterizes a building board with which the above-mentioned problem is solved.

Method claims 2 through 6 are directed to methods for producing a building board according to the invention.

The invention is described below based on a diagrammatic drawing by way of example and with further details. They show:

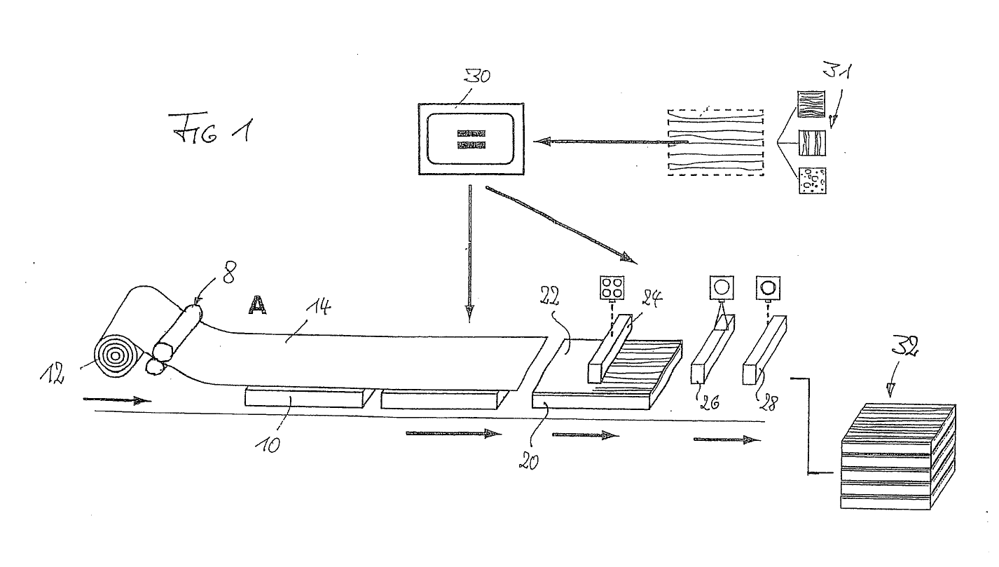

FIG. 1 Diagrammatically a sequence of the production of a building board, including the printing thereof, and

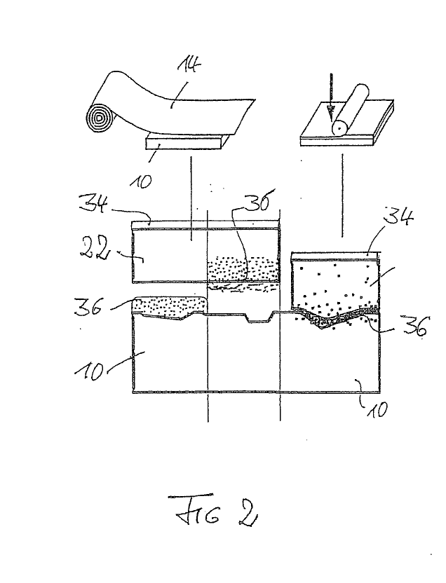

FIG. 2 Details of the method according to FIG. 1.

Building boards, such as are described below, can be used in different ways, for example, as a wall element, ceiling element, cladding element, floor element, etc.

According to FIG. 1 a base body 10 to be further processed to form a building board is provided, which is produced in a manner known per se. In general such boards forming the base body are produced in a floating process, in which a material forming the later base body, for example, plaster, optionally lined on both sides with paper or cardboard, mineral fiber material, wood fiber material or synthetic fiber material, which is preferably mixed with water, is applied to a liquid-permeable transport belt, on which the material dries, optionally while running through press rolls, whereby the water exits through the surface of the later base body. After drying, a strengthened base body is produced, the surface of which is very porous and unsuitable for printing due to the high absorbability.

A possibility is explained below of how a printed building board is produced from a preferably plate-like base body, which has a porous surface and a thickness of, for example, between 5 mm and 40 mm.

According to FIG. 1, a paper web 14 is unwound from a supply roll 12, which paper web is composed of a paper known per se with a preferably inkjet-capable surface or a surface that is printable by a programmable printing method, but which can also be composed of a more cost-effective simple paper, the surface of which is unsuitable for a direct inkjet printing. On its top side according to FIG. 1, the paper web is provided with a primer in a coating device 8 known per se. The coating device 8 can contain, for example, in a manner known per se an application roll charged with the primer, which bears against the top side of the paper web 14 and opposite which a counter roll is arranged, wherein the paper web runs through between the two rolls. The coating device 8 can also have print bars arranged above the paper web 14 from which the primer liquid is sprayed onto the paper web, a brush application device, etc. Alternatively, the paper web wound on the supply roll 12 can already be coated with primer on one side, in that the primer coating is directly following the production process of the paper web or is integrated therein.

The paper web provided with the primer is applied to the base body 10 in a manner that is not shown but is known per se, in that, for example, the bottom of the paper web 14 and/or the top of the base body 10 is provided with an adhesive layer that adheres to the porous or absorbent surface of the base body and the bottom of the paper web and after curing, connects the paper web firmly to the base body. The quantity and flowability of the adhesive material, for example, an aqueous dispersion adhesive, are advantageously coordinated with the surface of the base body such that any irregularities in the surface of the base body are leveled by the dispersion adhesive and the surface of the paper web coated with primer pasted onto the base body forms an even surface. Advantageously, the quantity and the flowability of the adhesive material are furthermore coordinated with the paper web 14 such that the adhesive material does not completely penetrate the paper web 14. Any adhesive material penetrating completely through the paper web is retained by the primer layer, which forms a barrier layer for the adhesive material and on its free surface remains unaffected by the adhesive material.

The base body is advantageously lined on both sides, in that it is lined, for example, on the underside with a counteracting paper, which, if necessary, is likewise coated with a primer. The lining on both sides means that the body produced does not warp or distort.

The primer applied to the paper web closes the surface pores of the paper web and forms an adhesion promoter for dyeing liquid to be applied to the building board, for example, by means of a programmable printing method. If the primer is not totally covering, the paper web advantageously has a pale-colored surface. If the primer is totally covering, it is advantageously pale-colored itself.

The paper web is advantageously stretchable such that during the application onto the base body, it adapts to the surface thereof, if the latter is arched in a three-dimensional manner, for example.

The building board 20, which is lined with the paper layer 20 provided on the surface with primer, in the example shown is printed in a printing station 24 by means of an inkjet printing method, that is, with a predetermined pattern by means of a print head or a print bar in a manner known per se and subsequently dried in a drying station 26 and in a hardening station 28 is finally provided with a hardening layer that is translucent, that has a high degree of hardness, is also resistant to aggressive liquids and is UV stable. It is understood that the drying station and the hardening station are not mandatory.

The printing station 24 is known per se in its structure and contains, for example, one or more print bars arranged one behind the other, which extends or extend transversely over the building board 20 and has or have a plurality of spray nozzles on the underside. Alternatively, a print bar can also be formed by an inkjet head with one or more spray nozzles, which moves transversely over the base body based on the transport direction of the base body 10 shown by the arrows. An embodiment is advantageous with stationary print bar and building board 20 moving under the print bar in a linear manner. The transport of the base body 10 or building boards 20 can be carried out in a manner known per se by means of a transport belt, a conveyor belt, etc. A slicing station is not shown in FIG. 1, in which the paper web 14 after pasting to the base body 10 is cut or sliced according to the shape of the base body. It is understood that the base body initially can form a continuous band and can be cut only after pasting.

To control the whole device an electronic control device 30, known per se in terms of its structure, in which patterns to be printed can be artificially produced or scanned in from pattern samples 31 is provided. The finished building boards are deposited in a stack 32, for example.

Advantageous details of the production of FIG. 1 are explained below based on FIG. 2; the perpendicular separation lines thereby indicate in each case individual process steps.

According to FIG. 2 a binder or an adhesive material 36 is applied to the top of the porous, generally somewhat uneven base body 10 and/or to the underside on its top of the paper web 14 provided with a primer layer or a primer 34. The binder can be, for example, resin, glue or also a melting adhesive. Subsequently, the paper web 14 with the binder 36 arranged between it and the base body 10 is pressed onto the base body 10, which can be carried out by a press or by rolling (pasting). If cavities between the base body 10 and the paper web 14 are not directly filled by deformation, they are filled by the curing binder 30, so that the surface of the paper layer 22 or of the primer 36 is even. The paper web 10 advantageously has a certain stretchability due to corresponding pretreatment, for example, by wet-creping, so that during application it adapts to a three-dimensionality or a relief of its substrate. Furthermore, the paper web is advantageously flame-resistant.

Binder 36, which diffuses through the paper web 14 before complete curing (indicated as points in the paper web 14 in the right-hand section of FIG. 2), is prevented by the primer 36 from further penetration. The free surface of the primer 36 thus forms a homogenous surface, which covers possible binder residues and forms a base surface for the dyeing liquid or dyeing liquids subsequently applied by means of a programmable printing process.

The composition of the primer is advantageously determined by the paper web used, the dyeing liquid and the binder, wherein the primer is not only to close the pores of the paper web, but is also to form an adhesion promoter for the dyeing liquid and a barrier layer for the binder.

If the paper is pale-colored, due to an incorporation of, e.g., titanium oxide preferably is penetration-dyed white, or at least has a pale-colored, advantageously white upper layer, the primer can be colorless or have a base tint. If low-cost paper is used, which does not have a pale-colored top side directly suitable for printing, the primer is advantageously pigmented in a pale-colored manner, preferably white. The primer can also have a different base coloring; for example, if a wood decoration is to be printed on, a base coloring of the primer is advantageous which corresponds to the palest tint of the wood decoration to be printed on.

In any case, the primer forms a closure of the paper surface and an adhesion promoter for the dyeing liquid(s) subsequently applied. Primers on a polyurethane basis, polyester basis or also epoxy resin basis, known per se, can be used as primer or adhesion promoter. In the case of two-component systems, the two components are applied for example in immediate succession from spray nozzles or at the same time from different spray nozzles onto the same target points of the surface, whereby a particularly intensive mixing of the two components and thereby a good quality of the primer surface is achieved.

The building boards with finished printing according to the invention can be used, for example, individually as decorative cladding boards or in a predetermined manner can be combined in a plurality to form a complete wall cladding, wherein the seams between the building boards are discernible at most upon close inspection. Patterns can be composed from the building boards according to the invention, wherein the contours of the building boards themselves can contribute to the ornamentation of the pattern. The examples given for compositions or other properties are not conclusive, but can be supplemented by other examples.

With a building board with a base body 10 with porous surface and a paper web 14 applied to the porous surface with the intermediate arrangement of a curable binder 36, the paper web applied onto the base body is provided with a primer (34), which is suitable for covering binder that has penetrated through the paper web (10) and for promoting an adhesion between the surface of the paper web and a dyeing liquid (38), which can be applied to the surface of the paper web provided with the adhesion promoter by means of a programmable printing method, in particular an inkjet printing method.

### List of Reference Numbers

8 Coating device
10 Base body
12 Supply roll
14 Paper web
16 Material layer
18 Roll
20 Building board
22 Paper layer
23 Cover layer
24 Printing station
26 Drying station
28 Hardening station
30 Electronic control device
31 Pattern samples
32 Stack
34 Primer
36 Binder
38 Dyeing liquid

1. A building board with a base body (10) with porous surface and a paper web (14) applied to the porous surface with the intermediate arrangement of a curable binder (36), characterized in that binder (36) has penetrated into the paper web (14), and that the paper web (14) applied onto the base body is provided with a primer (34) that is suitable for covering binder that has penetrated through the paper web (14) and for promoting an adhesion between the surface of the paper web and a dyeing liquid (38), which can be applied to the surface of the paper web (14), applied onto the base body (10) and provided with the primer (34) by means of a programmable printing method, in particular an inkjet printing method.

2. A method for producing a building board, containing the following process steps:
Provision of a plate-like base body (10) with a porous surface,
Provision of a paper web (14) coated on one side with a primer (34),
Application of a flowable binder (36) onto the porous surface of the base body and/or the side of the paper web (14) facing towards the base body and not coated with the primer,
Application of the paper web (14) onto the base body (10) with flowable binder (36) arranged therebetween,
Pressing or rolling of the paper web onto the base body, wherein the primer (34) is selected such that it covers binder that has penetrated through the paper web and forms an adhesion promoter for a dyeing liquid to be applied to the building board by means of the programmable printing method, characterized in that the primer (34) is further chosen such that it covers binder that has penetrated through the paper web.

3. The method according to claim 2, wherein the quantity of the flowable binder (36) is coordinated with the surface of the base body (10) such that the binder evens out irregularities in the surface of the base body and the surface of the paper web provided with primer (34) is even.

4. The method according to claim 2, wherein the paper web (14) to be applied to the base body (10) is pale-colored on its surface coated with the primer (34) and the primer applied to the pale-colored surface of the paper web closes pores of the surface of the paper web.

5. The method according to claim 2, wherein the primer (34) applied to the surface of the paper web (14) is pale-colored and covering and closes pores of the surface of the paper web.

6. The method according to claim 2, wherein the paper web (14) is stretchable such that during application onto the base body (10) it adapts to a three-dimensional surface structure of the substrate onto which it is applied.
